(19) United States
(12) Patent Application Publication
(10) Pub. No.: US 2016/0252013 A1
(43) Pub. Date: Sep. 1, 2016

(54) Piston Crown and Corresponding Port Geometry

(71) Applicant: AVL Powertrain Engineering, Inc., Plymouth, MI (US)

(72) Inventors: Iain Read, Warren, MI (US); Julian Sherborne, Novi, MI (US)

(21) Appl. No.: 15/050,583

(22) Filed: Feb. 23, 2016

Related U.S. Application Data
(60) Provisional application No. 62/121,994, filed on Feb. 27, 2015.

(51) Int. Cl. F02B 75/28; F02F 3/28

(52) U.S. Cl. CPC F02B 75/28; F02F 3/28

(57) ABSTRACT

An engine assembly including a cylinder wall extending about a cylinder bore is disclosed. A piston slidingly received within the cylinder bore includes a ring groove extending about the piston in a ring plane that is transverse to a longitudinal axis of the cylinder bore. A piston ring is received in the ring groove of the piston. A port extends through the cylinder wall to communicate fluid to or from the cylinder bore. The port has an oblique geometry relative to the ring plane and a plurality of windows that extend at least partially about the cylinder bore in a path that is transverse to the ring plane. The oblique geometry of the port staggers entry and exit of the piston ring relative to the plurality of windows as the piston reciprocates within the cylinder bore. This helps prevent the piston ring from clipping the port.

### CROSS-REFERENCE TO RELATED APPLICATIONS

This application claims the benefit of U.S. Provisional Application No. 62/121,994, filed on Feb. 27, 2015. The entire disclosure of the application referenced above is incorporated herein by reference.

### FIELD

The present disclosure generally relates to internal combustion engines. More particularly, an engine assembly is disclosed where at least one of the inlet and exhaust ports has an oblique geometry.

### BACKGROUND

This section provides background information related to the present disclosure which is not necessarily prior art.

In typical internal combustion engines, a cylinder is defined by a cylinder wall. A piston is slidingly disposed within the cylinder. Combustion forces within the cylinder of the internal combustion engine act on the piston and drive the piston in a reciprocating manner. The piston includes at least one piston ring received in a corresponding ring groove that extends about the piston. The piston ring contacts the cylinder wall and thus seals the piston against the cylinder wall. To maintain this seal, the piston ring exerts outward pressure against the cylinder wall. If the outward pressure exerted by the piston ring is too low, then the combustion forces can drive combustion gases between the cylinder wall and the piston. This unwanted condition, commonly referred to as “blow-by,” results in power loss and can cause engine damage. Accordingly, piston rings are designed to exert considerable outward pressure against the cylinder wall.

Many internal combustion engines, including many opposed-piston engines, have inlet ports and exhaust ports disposed along the cylinder wall. The inlet ports deliver an intake charge of either air or an air/fuel mixture into the cylinder for combustion. The exhaust ports transport the exhaust gases that are produced by combustion out of the cylinder so that a new intake charge can enter the cylinder. Typically, the inlet and exhaust ports are opened and closed by the piston as it passes by the inlet and exhaust ports. Such designs are commonly categorized as two-stroke engines; however, it should be appreciated that the subject disclosure is not limited to just two-stroke engines. One problem that exists with any engine that has an inlet port or an exhaust port that is opened and closed by the piston is that the piston ring has a tendency to catch the port as the piston reciprocates within the cylinder. This condition is commonly referred to as “ring clipping.” Generally, the entire piston ring enters and exits the port at the same time and the outward pressure exerted by the piston ring causes a portion of the piston ring to migrate outwardly from the ring groove and into the port. Small migrations of the piston ring leads to excessive wear of the piston ring and/or the inlet and exhaust ports resulting in shorter engine life and compression loss. Larger migrations of the piston ring can cause catastrophic ring and piston failure resulting in expensive engine damage.

The ring clipping problem can be especially problematic in opposed-piston engines because opposed-piston engines often utilize high compression ratios, requiring piston rings that exert more outward pressure on the cylinder wall to maintain a seal. Opposed-piston engines generally include two pistons housed within each cylinder that move in an opposed, reciprocal manner within the cylinder. In this regard, during one stage of operation the pistons are moving away from one another within the cylinder and during another stage of operation the pistons are moving towards one another within the cylinder. As the pistons move towards one another within the cylinder, they compress and, thus, cause ignition of a fuel/air mixture disposed within the cylinder. In so doing, the pistons are forced apart from one another, thereby exposing the inlet ports and the exhaust ports. Exposing the inlet ports draws air into the cylinder and this in combination with exposing the exhaust ports expels exhaust, thereby allowing the process to begin anew. When the pistons are forced apart from one another, connecting rods coupled to each piston transfer the linear motion of the pistons within the cylinder to one or more crankshafts that are coupled to the connecting rods. The forces imparted on the connecting rods thus cause rotation of the crankshafts which, in turn, cause rotation of wheels of a vehicle in which the internal combustion engine is installed. However, it should be appreciated that the ring clipping problem can occur in any engine that has a port in the cylinder wall that is opened and closed by movement of a piston. Accordingly, the subject disclosure is not limited to opposed piston engines, but is applicable to a wide variety of different engine types, including without limitation, compression-ignition engines (e.g. diesel engines), spark-ignition engines, two-stroke engines, and four-stroke engines of various cylinder arrangements.

### SUMMARY

This section provides a general summary of the disclosure, and is not a comprehensive disclosure of its full scope or all of its features.

In accordance with one aspect of the subject disclosure, an engine assembly is provided. The engine assembly includes a cylinder wall extending about a cylinder bore and a piston slidingly received within the cylinder bore. The cylinder bore defines a longitudinal axis and the piston is movable along this longitudinal axis. The piston includes at least one ring groove that extends about the piston in a ring plane that is transverse to the longitudinal axis. At least one piston ring is received in the at least one ring groove of the piston. The engine assembly further includes at least one port extending through the cylinder wall that is open to the cylinder bore. The at least one port has an oblique geometry relative to the ring plane. The at least one port includes a plurality of windows that extend at least partially about the cylinder bore in a path that is oblique to the ring plane. Accordingly, the oblique geometry of the at least one port staggers entry and exit times of the at least one piston ring relative to the plurality of windows of at least one port as the piston reciprocates within the cylinder bore.

In accordance with another aspect of the subject disclosure, an opposed piston engine is provided. The opposed piston engine includes an engine block that has a cylinder wall extending about and defining a first cylinder. The first cylinder has a first longitudinal axis. The first cylinder also includes a first inlet port and a first exhaust port, each being disposed in the cylinder wall. The first exhaust port is longitudinally spaced from the first inlet port. A pair of first pistons including a first piston and a first opposing piston are slidably disposed within the first cylinder. The pair of first pistons are movable along the first longitudinal axis toward one another in a first mode of operation and away from one another in a second mode of operation. Each piston includes a piston crown and at least one ring groove that extends about each piston in a ring plane that is perpendicular to the first longitudinal axis. At least one piston ring is received in the at least one ring groove of each piston. At least one of the first inlet port and the first exhaust port has an oblique geometry thereby defining at least one oblique port. The at least one oblique port has a plurality of windows extending at least partially about the first cylinder in a path that is oblique to the ring plane. Accordingly, the oblique geometry of the oblique port staggers entry and exit times of the at least one piston ring relative to the plurality of windows of the at least one oblique port as the pair of first pistons translate within the first cylinder.

The disclosed engine design solves the ring clipping problem because the oblique geometry of the port is not aligned with the ring plane. Entry and exit of the piston ring does not occur abruptly along the entire piston ring like in known designs, but occurs gradually along the piston ring. Due to the oblique geometry of the port, there is no point in piston travel where the entire piston ring transitions from the cylinder wall to the port or where the entire piston ring transitions from the port to the cylinder wall. Instead, the piston ring crosses only some of the windows in the plurality of windows of the port at a given moment in time. For these reasons, the oblique geometry of the port advantageously increases ring life, decreases wear, and improves reliability.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a partial perspective view of an exemplary engine assembly constructed in accordance with the subject disclosure where the piston has a concave piston crown;

FIG. 2 is a partial perspective view of an exemplary engine assembly constructed in accordance with the subject disclosure where the piston has a domed piston crown;

FIG. 3 is a partial plane view of an exemplary cylinder constructed in accordance with the subject disclosure where the cylinder wall has been unwrapped to illustrate the oblique geometry of the inlet and exhaust ports;

FIG. 4 is a front elevation view of the exemplary piston illustrated in FIG. 1;

FIG. 5 is a partial cross-section view of the exemplary piston and port geometry illustrated in FIG. 1 where the ports are open to the cylinder bore;

FIG. 6 is a partial cross-section view of the exemplary piston and port geometry illustrated in FIG. 1 where translation of the piston is closing the ports;

FIG. 7 is a partial cross-section view of the exemplary piston and port geometry illustrated in FIG. 1 where the ports are closed to the cylinder bore by the piston;

FIG. 8 is a partial cross-section view of an exemplary opposed-piston engine constructed in accordance with the subject disclosure where the first piston and the first opposing piston are spaced apart at a bottom dead-center position;

FIG. 9 is a partial cross-section view of the exemplary opposed-piston engine illustrated in FIG. 8 where the first piston and the first opposing piston are nested together at a top dead-center position;

FIG. 10 is a partial perspective view of another exemplary opposed-piston engine constructed in accordance with the subject disclosure where an engine block defines multiple cylinders;

FIG. 11 is a partial cross-section view of the first cylinder of the exemplary opposed-piston engine illustrated in FIG. 10; and

FIG. 12 is a partial cross-section view of the second cylinder of the exemplary opposed-piston engine illustrated in FIG. 10.

### DETAILED DESCRIPTION

Referring to the Figures, wherein like numerals indicate corresponding parts throughout the several views, an engine assembly 20 is disclosed.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

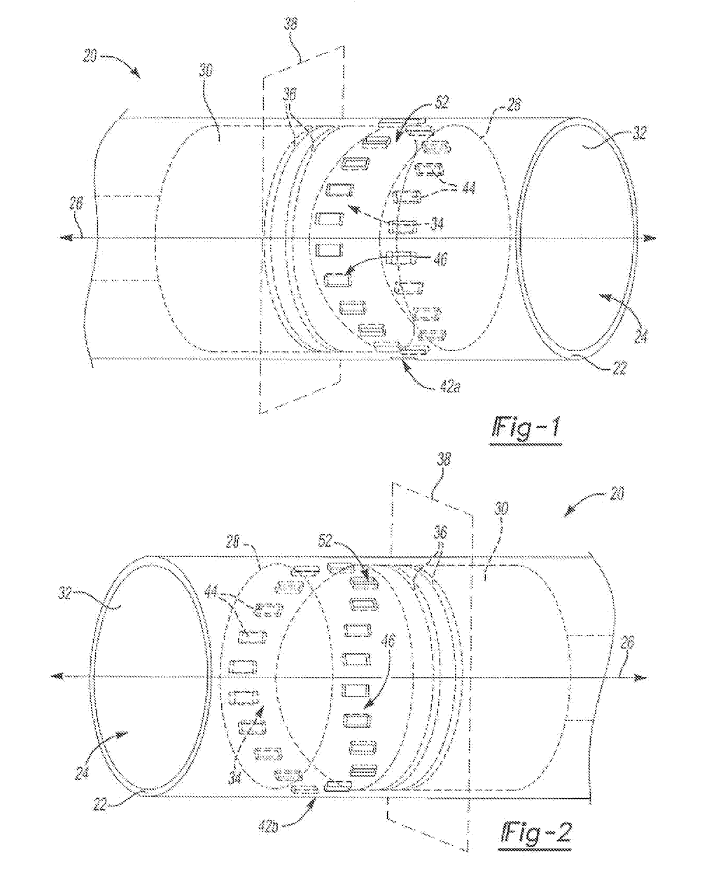

Referring to FIGS. 1 and 2, an engine assembly 20 is illustrated. It should be appreciated that such an engine assembly 20 comprises part of a larger internal combustion engine. The internal combustion engine may be of a variety of different types, including without limitation, a two-stroke engine or a four-stroke engine. Further, the internal combustion engine may be designed to run on one or more of a variety of different fuels, including diesel fuel (e.g. a compression ignition engine) and gasoline (e.g. a spark ignition engine).

The engine assembly 20 includes a cylinder wall 22 that extends annularly about a cylinder bore 24. In this way, the cylinder wall 22 defines a size and shape of the cylinder bore 24. The cylinder bore 24 has a longitudinal axis 26 that extends co-axially through the cylinder bore 24. The cylinder bore 24 also has a bore cross-section 28 that is perpendicular to the longitudinal axis 26. While the cylinder bore 24 and thus the bore cross-section 28 may have a variety of different shapes, by way of example and without limitation, the bore cross-section 28 may have a circular perimeter.

A piston 30 is slidingly received within the cylinder bore 24 for reciprocal movement therein along the longitudinal axis 26 between a bottom dead-center position and a top dead-center position. As is commonly known in the internal combustion engine field, the term “bottom dead-center” describes a position of the piston 30 where the piston 30 is at the bottom of its stroke (i.e. where the piston 30 is closest to the engine's crankshaft). Similarly, the term “top dead-center” describes a position of the piston 30 where the piston 30 is at the top of its stroke (i.e. where the piston 30 is farthest from the crankshaft). The piston 30 translates within the cylinder bore 24 by sliding relative to the cylinder wall 22 and more specifically an inner surface 32 of the cylinder wall 22. Thus, it should be appreciated that the inner surface 32 of the cylinder wall 22 faces the piston 30. The piston 30 generally includes a piston crown 34 that spans the bore cross-section 28. Notwithstanding the fact that the piston crown 34 spans the bore cross-section 28, it should be appreciated that there may be a clearance gap between the piston crown 34 and the inner surface 32 of the cylinder wall 22. The piston crown 34 shown in FIG. 1 has a concave shape while the piston crown 34 shown in FIG. 2 has a domed shape. The piston 30 also includes at least one ring groove 36 that extends annularly about the piston 30 in a ring plane 38 that is perpendicular to the longitudinal axis 26 and parallel to the bore cross-section 28.

As best seen in FIG. 4, at least one piston ring 40 is received in the at least one ring groove 36. The piston ring 40 has an annular shape and has a cross-sectional profile that extends radially within the ring plane 38 from the piston 30 to the inner surface 32 of the cylinder wall 22. Accordingly, the piston ring 40 abuts the inner surface 32 of the cylinder wall 22 and seals against the inner surface 32 of the cylinder wall 22 to prevent the blow-by of combustion gases. Of course the piston 30 may include multiple ring grooves 36, each receiving one of several piston rings 40. In FIG. 4, several piston rings 40 are illustrated defining multiple ring planes 38 that are generally parallel with one another.

As illustrated in FIGS. 1 and 2, the cylinder wall 22 has one or more ports 42a, 42b that extend through the cylinder wall 22 and that are open to the cylinder bore 24. For example and without limitation, the cylinder wall 22 may include two ports 42a, 42b where one of the ports 42a operates to draw exhaust gases from the cylinder bore 24 and the other one of the ports 42b operates to supply intake air or an air/fuel mixture to the cylinder bore 24. Each port 42a, 42b includes a plurality of windows 44 that are circumferentially spaced from one another about the cylinder wall 22. Each window 44 of the plurality of windows 44 may have a window perimeter 46 that extends about each window 44 of the plurality of windows 44 adjacent the inner surface 32 of the cylinder wall 22. The window perimeters 46 of the plurality of windows 44 may cooperatively define the ports 42a, 42b.

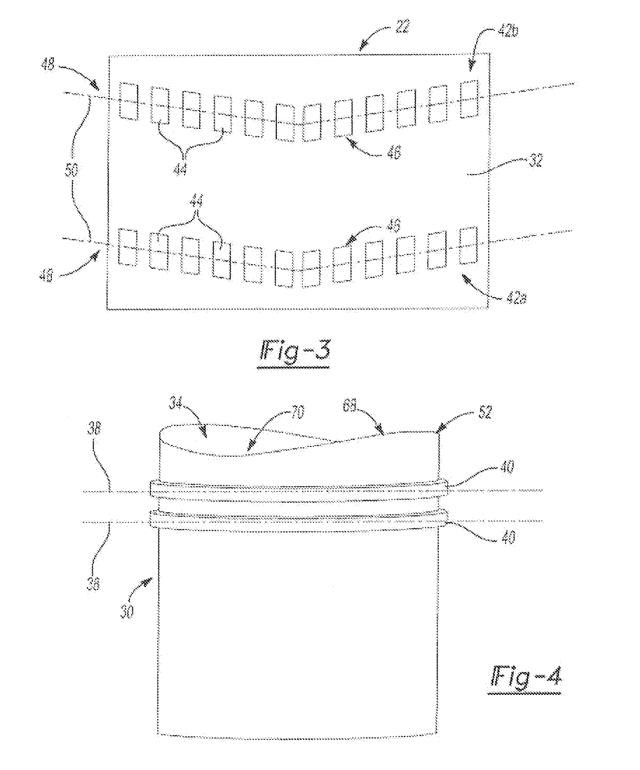

As best seen in FIG. 3, the ports 42a, 42b each have an oblique geometry 48 relative to the ring plane 38. The term “oblique geometry,” as used herein, means that the ports 42a, 42b extend about the cylinder bore 24 in a path 50 that is oblique to (i.e. forms an oblique angle with) the ring plane 38. This oblique geometry 48 staggers entry and exit times of the at least one piston ring 40 relative to the plurality of windows 44 of the ports 42a, 42b as the piston 30 reciprocates within the cylinder bore 24 between the bottom dead-center position and the top dead-center position. In other words, the at least one piston ring 40 crosses the window perimeters 46 of the plurality of windows 44 at varying time intervals to reduce the likelihood of ring clipping. For example, the at least one piston ring 40 first crosses the windows 44 disposed toward the center of FIG. 3 as the piston 30 translates upwards along the cylinder wall 22 illustrated in FIG. 3. As the piston 30 continues its upward movement, the at least one piston ring 40 gradually crosses the windows 44 staggered to each side of the centrally located windows 44. The at least one piston rings 40 transitions into full contact with the inner surface 32 of the cylinder wall 22 in this same gradual manner. While the oblique geometry 48 of the ports 42a, 42b may take a variety of different shapes, by way of example and without limitation, the path 50 in which the ports 42a, 42b extend circumscribes the cylinder bore 24 and may be a sinusoidal path as shown in FIG. 3.

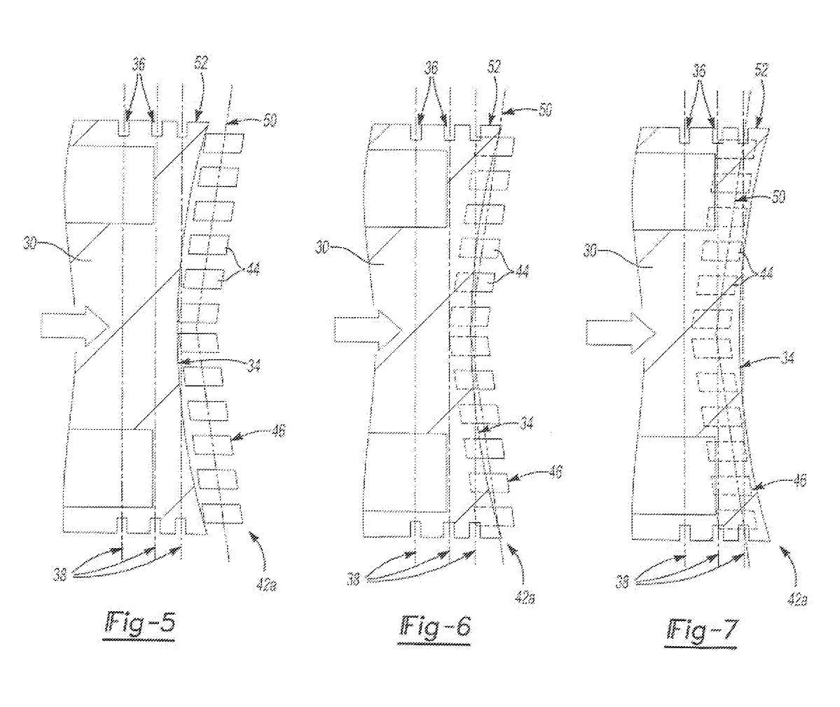

As shown in FIGS. 1, 2 and 4, the piston crown 34 has a periphery 52 adjacent the cylinder wall 22 that forms an oblique angle with the ring plane 38 and that has a shape corresponding to the oblique geometry 48 of the ports 42a, 42b. For example, the periphery 52 of the concave piston crown 34 of FIG. 1 corresponds to the oblique geometry 48 of the port 42a shown in FIG. 1. Similarly, the periphery 52 of the domes piston crown 34 of FIG. 2 corresponds to the oblique geometry 48 of the port 42b shown in FIG. 2. With reference to FIGS. 5-7, the shape of the periphery 52 of the piston crown 34 opens and closes the plurality of windows 44 at substantially the same time along the oblique geometry 48 of the at least one port 42 as the piston 30 reciprocates within the cylinder bore 24 between the bottom dead-center position and the top dead-center position. By way of example, the periphery 52 of the piston crown 34 may open and close the plurality of windows 44 of the at least one port 42 within 0.2 milliseconds (ms) of one another, where the internal combustion engine is operating at a speed of 2100 revolution per minute (RPM), has a stroke of 210 millimeters (mm), and a port placement to piston crown tolerance of plus or minus (+/−) 1 millimeter (mm). In FIGS. 5-7, the piston 30 is moving from left to right. In FIG. 5, the periphery 52 of the piston crown 34 is approaching the plurality of windows 44 of port 42a. Although the oblique geometry 48 of port 42a staggers entry and exit times of the at least one piston ring 40, it can be seen in FIG. 5 that the shape of the periphery 52 of the piston crown 34 corresponds with the oblique geometry 48 of port 42a and allows all portions of the periphery 52 of the piston crown 34 to concurrently approach the plurality of windows 44. In FIG. 6 the piston 30 has moved such that the periphery 52 of the piston crown 34 is closing the plurality of windows 44 at substantially the same time across port 42a. Finally, FIG. 7 shows the shape of the periphery 52 allows the piston crown 34 to close the plurality of windows 44 of port 42a at substantially the same time. Accordingly, the disclosed engine assembly 20 provides a solution to the ring clipping problem without changing the timing of the opening and closing of port 42a. The same teachings may be applied to port 42b in configurations where the cylinder wall 22 has two ports 42a, 42b.

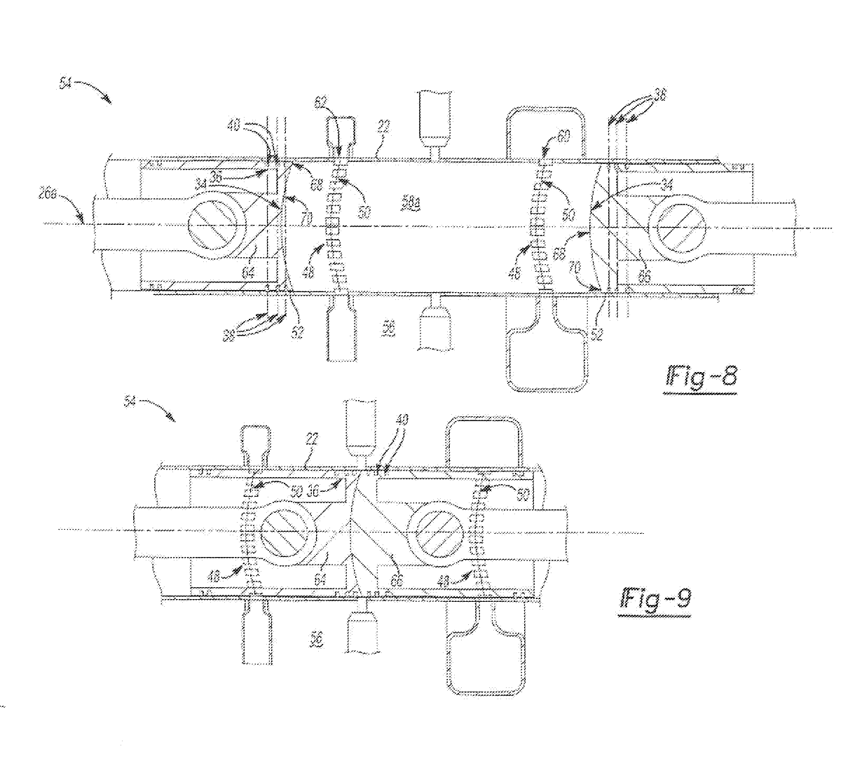

FIGS. 8-10 illustrate an opposed-piston engine 54 that utilizes the disclosed piston crown and port geometry. The opposed-piston engine 54 includes an engine block 56 with a cylinder wall 22 that extends about and defines a first cylinder 58a. The first cylinder 58a has a first longitudinal axis 26a extending co-axially through the first cylinder 58a. The first cylinder 58a also has a first inlet port 60 and a first exhaust port 62 that is longitudinally spaced from the first inlet port 60. Both the first inlet port 60 and the first exhaust port 62 extend through the cylinder wall 22 and are open to the first cylinder 58a. An intake charge of air or an air/fuel mixture is supplied to the first cylinder 58a of the opposed-piston engine 54 through the first inlet port 60. This intake charge undergoes combustion within the first cylinder 58a. Combustion of the intake charge produces exhaust gasses, which exit the first cylinder 58a through the first exhaust port 62.

As best seen in FIGS. 8 and 9, the opposed-piston engine 54 has a pair of first pistons 64, 66 including a first piston 64 and a first opposing piston 66 that are slidably disposed within the first cylinder 58a. More particularly, the first piston 64 and the first opposing piston 66 are movable along the first longitudinal axis 26a toward one another in a first mode of operation and away from one another in a second mode of operation. In embodiments where the opposed-piston engine 54 is a two-stroke engine, the intake charge is compressed by the pair of first pistons 64, 66 during the first mode of operation. This compression may cause the intake charge to ignite when the pair of first pistons 64, 66 are at or near the top dead-center position shown in FIG. 9. The resulting combustion of the intake charge drives the pair of first pistons 64, 66 apart during the second mode of operation. Alternatively, spark ignition may be used to control ignition of the intake charge during the first mode of operation. As the pair of first pistons 64, 66 are driven apart during the second mode of operation, the pair of first pistons 64, 66 pass by the first inlet port 60 and first exhaust port 62 as the pair of first pistons 64, 66 move to the bottom dead-center position shown in FIG. 8. In accordance with the outward movement of the pair of first pistons 64, 66, the first inlet port 60 and the first exhaust port 62 are opened and become exposed to the first cylinder 58a. Exhaust gases thus exit the first cylinder 58a through the first exhaust port 62 and a new intake charge enters the first cylinder 58a through the first inlet port 60 such that the engine cycle may begin anew.

Each piston of the pair of first pistons 64, 66 includes a piston crown 34 and one or more ring grooves 36. The ring grooves 36 extend about each piston of the pair of first pistons 64, 66 in respective ring planes 38 that are perpendicular to the first longitudinal axis 26a. A piston ring 40 is received in each of the ring grooves 36 of the first piston 64 and the first opposing piston 66 to seal the pair of first pistons 64, 66 against the cylinder wall 22. At least one of the first inlet port 60 and the first exhaust port 62 has an oblique geometry 48 thereby defining at least one oblique port 60, 62, which extends about the first cylinder 58a in a path 50 that forms an oblique angle with the ring plane 38. This staggers entry and exit times of the at least one piston ring 40 relative to the at least one port 60, 62 as the pair of first pistons 64, 66 translate within the first cylinder 58a. The piston crown 34 of at least one piston 30 of the pair of first pistons 64, 66 has a periphery 52 that corresponds to the oblique geometry 48 of the at least one oblique port 60, 62 thereby defining at least one oblique piston crown 34. The periphery 52 of the at least one oblique piston crown 34 opens and closes the at least one oblique port 60, 62 at substantially the same time along the oblique geometry 48 as the pair of first pistons 64, 66 translate within the first cylinder 58a.

In some embodiments, including in the one shown in FIGS. 8 and 9, the first inlet port 60 and the first exhaust port 62 both have an oblique geometry 48. Thus, the first inlet port 60 and the first exhaust port 62 both extend at least partially about the first cylinder 58a in a path 50 that is transverse to the ring plane 38 to stagger entry and exit times of the at least one piston ring 40 relative to each of the first inlet and exhaust ports 60, 62 as the pair of first pistons 64, 66 translate within the first cylinder 58a. The periphery 52 of the piston crown 34 of the first piston 64 and the first opposing piston 66 may have a shape that corresponds to the oblique geometry 48 of the first inlet port 60 and the first exhaust port 62. As a result, the periphery 52 of the piston crown 34 of the first piston 64 may open and close the first inlet port 60 at substantially the same time (i.e. evenly) along the oblique geometry 48 of the first inlet port 60 as the pair of first pistons 64, 66 translate within the first cylinder 58a. Similarly, the periphery 52 of the piston crown 34 of the first opposing piston 66 may open and close the first exhaust port 62 at substantially the same time (i.e. evenly) along the oblique geometry 48 of the first exhaust port 62 as the pair of first pistons 64, 66 translate within the first cylinder 58a.

The oblique geometry 48 of the piston crown 34 of the first piston 64 and the first opposing piston 66 may create a non-planar (i.e. uneven) periphery 52. For example, the periphery 52 of the piston crown 34 of the first piston 64 may have high areas 68 and low areas 70. The periphery 52 of the piston crown 34 of the first opposing piston 66 may also have high areas 68 and low areas 70. In accordance with another aspect of the present disclosure, the first piston 64 and the first opposing piston 66 may be phased or rotated with respect to one another such that the high areas 68 of the first piston 64 interface with the low areas 70 of the first opposing piston 66 and the low areas 70 of the first piston 64 interface with the high areas 68 of the first opposing piston 66. The first piston 64 may therefore nest with the first opposing piston 66 as the first piston 64 and the first opposing piston 66 approach one another during the first mode of operation. This nesting arrangement of the first piston 64 and the first opposing piston 66 is illustrated in FIG. 9 where the pair of first pistons 64, 66 are shown in the top dead-center position. Advantageously, this allows for closer approach of the pair of first pistons 64, 66 to maximize compression within the first cylinder 58a and decrease the overall length of the first cylinder 58a.

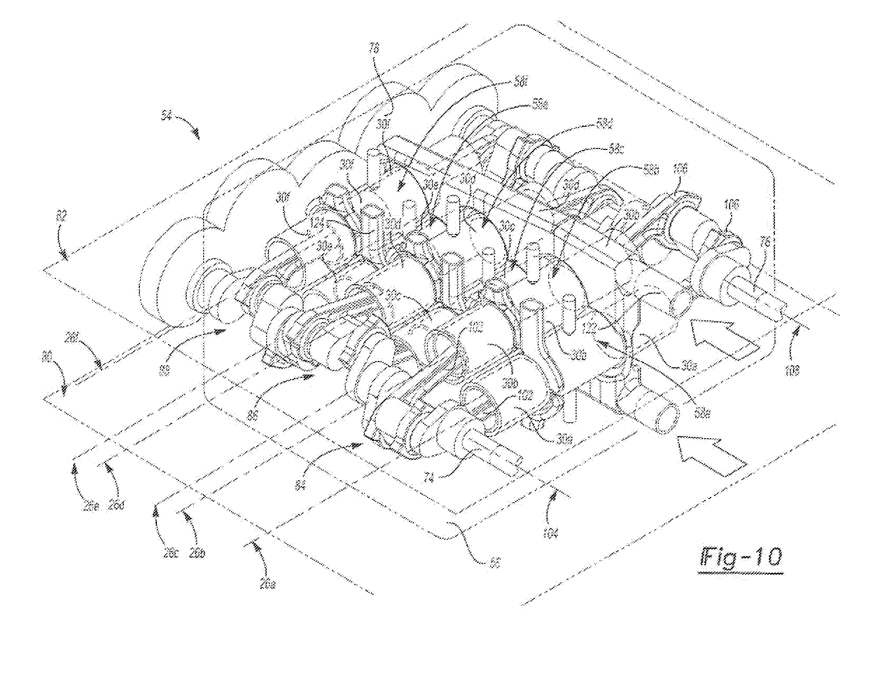

With reference to FIG. 10, the engine block 56 of the opposed-piston engine 54 may define a series of cylinders 58a, 58b, 58c, 58d, 58e, 58f. Each cylinder 58a, 58b, 58c, 58d, 58e, 58f includes a pair of pistons 30a, 30b, 30c, 30d, 30e, 30f slidably disposed therein and selectively movable toward one another (FIG. 9) and away from one another (FIG. 8). Movement of the pistons 30a, 30b, 30c, 30d, 30e, 30f relative to and within the cylinders 58a, 58b, 58c, 58d, 58e, 58f drives a pair of crankshafts 74, 76 which, in turn, drive a gear train 78. The gear train 78 may be connected to driven wheels of a vehicle (not shown), for example, whereby the pair of crankshafts 74, 76 and the gear train 78 cooperate to transform the linear motion of the pistons 30a, 30b, 30c, 30d, 30e, 30f relative to the cylinders 58a, 58b, 58c, 58d, 58e, 58f into rotational motion to allow the motion of the pistons 30a, 30b, 30c, 30d, 30e, 30f to rotate the driven wheels and propel the vehicle.

The cylinders 58a, 58b, 58c, 58d, 58e, 58f are housed within the engine block 56 and each includes a longitudinal axis 26a, 26b, 26c, 26d, 26e, 26f that extends substantially perpendicular to an axis of rotation 104, 108 of each crankshaft 74, 76. As shown in FIG. 10, the cylinders 58a, 58b, 58c, 58d, 58e, 58f may be offset from one another. The longitudinal axes 26a, 26c, 26e of the cylinders 58a, 58c, 58e are aligned with one another such that a primary cylinder plane 80 extends through each of the longitudinal axes 26a, 26c, 26e that is substantially parallel to the axes of rotation 104, 108 of the crankshafts 74, 76. Similarly, a secondary cylinder plane 82 intersecting longitudinal axes 26b, 26d, 26f of the cylinders 58b, 58d, 58f is substantially parallel to the axes of rotation 104, 108 of the crankshafts 74, 76. The primary cylinder plane 80 is substantially parallel to and is offset from the secondary cylinder plane 82, as the primary cylinder plane 80 is disposed on an opposite side of the plane extending through the axes of rotation 104, 108 of the crankshafts 74, 76 relative to the secondary cylinder plane 82. Further, cylinder 58c is disposed between cylinders 58a, 58e and cylinder 58d is disposed between cylinders 58b, 58f. Accordingly, the configuration of the cylinders 58a, 58b, 58c, 58d, 58e, 58f shown in FIG. 10 creates a so-called “nested” arrangement, which allows the cylinders 58a, 58b, 58c, 58d, 58e, 58f to be packaged in a smaller engine block 56. Notwithstanding, it should be appreciated that the scope of the present disclosure is not limited to this number of cylinders 58a, 58b, 58c, 58d, 58e, 58f or the configuration illustrated in FIG. 10.

The cylinders 58a, 58b, 58c, 58d, 58e, 58f of the opposed-piston engine 54 may be grouped into cylinder pairs 84, 86, 88 where cylinders 58a, 58b are grouped in a first cylinder pair 84, cylinders 58c, 58d are grouped in a second cylinder pair 86, and cylinders 58e, 58f are grouped in a third cylinder pair 88. Because the relative structure and function of the first cylinder pair 84 is the same as the second and third cylinder pairs 86, 88, the following disclosure focuses on the first cylinder pair 84 with the understanding that the same also applies to the second and third cylinder pairs 86, 88 of the opposed-piston engine 54 illustrated in FIG. 10.

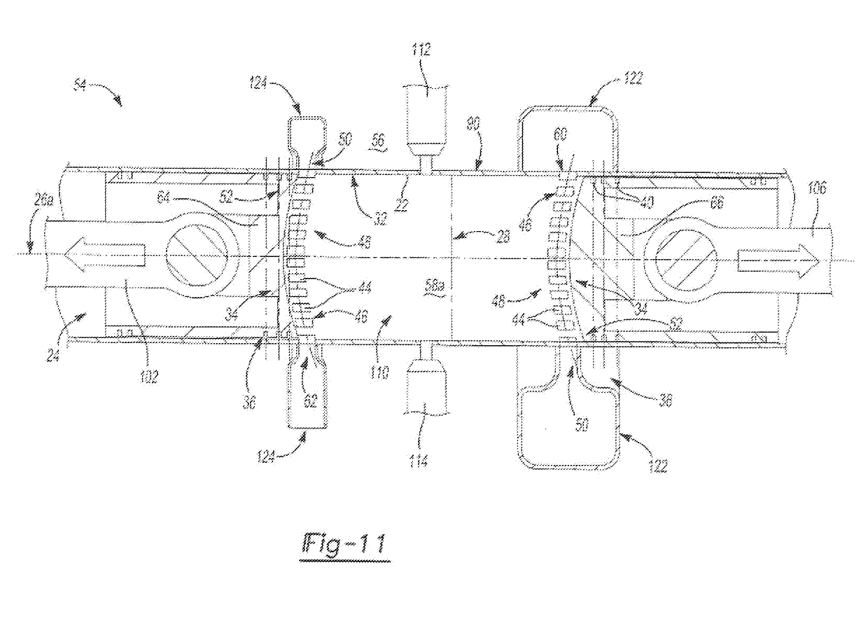

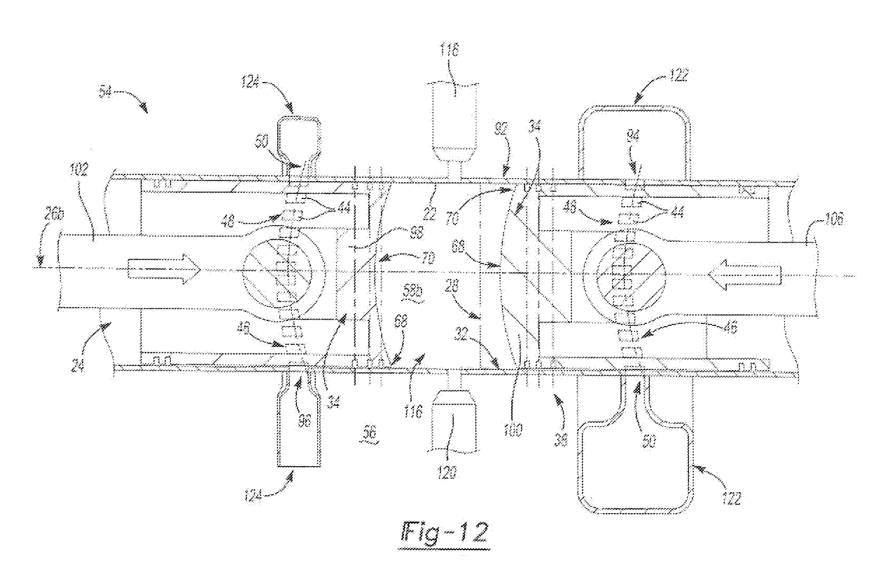

With reference to FIGS. 11 and 12, a plurality of cylinder liners 90, 92 are disposed within the engine block 56. Each cylinder liner of the plurality of cylinder liners 90, 92 defines a cylinder wall 22 that extends annularly about and defines a cylinder bore 24. The plurality of cylinder liners 90, 92 includes a first cylinder liner 90 that defines a first cylinder 58a and a second cylinder liner 92 that defines a second cylinder 58b. With reference to FIG. 11, the first cylinder 58a has a first longitudinal axis 26a that extends co-axially through the first cylinder 58a. The first cylinder 58a has a first inlet port 60 and a first exhaust port 62 that is longitudinally spaced from the first inlet port 60. Both the first inlet port 60 and the first exhaust port 62 extend through the cylinder wall 22 of the first cylinder liner 90 and are arranged in fluid communication with the cylinder bore 24 of the first cylinder 58a. A pair of first pistons 64, 66 including a first piston 64 and a first opposing piston 66 are slidably disposed within the first cylinder 58a and are movable along the first longitudinal axis 26a. For example, the pair of first pistons 64, 66 may move toward one another along the first longitudinal axis 26a in a first mode of operation and away from one another along the first longitudinal axis 26a in a second mode of operation as the pair of first pistons 64, 66 translate between a bottom dead-center position and a top dead-center position.

Referring now to FIG. 12, the second cylinder 58b has a second longitudinal axis 26b that extends co-axially through the second cylinder 58b. The second cylinder 58b has a second inlet port 94 and a second exhaust port 96 that is longitudinally spaced from the second inlet port 94. Both the second inlet port 94 and the second exhaust port 96 extend through the cylinder wall 22 of the second cylinder liner 92 and are arranged in fluid communication with the cylinder bore 24 of the second cylinder 58b. The second cylinder 58b is disposed adjacent to the first cylinder 58a such that the first longitudinal axis 26a of the first cylinder 58a is parallel with and spaced from the second longitudinal axis 26b of the second cylinder 58b. Further, the first and second cylinders 58a, 58b are arranged such that the first inlet port 60 of the first cylinder 58a is longitudinally aligned with the second inlet port 94 of the second cylinder 58b and such that the first exhaust port 62 of the first cylinder 58a is longitudinally aligned with the second exhaust port 96 of the second cylinder 58b.

A pair of second pistons 98, 100 including a second piston 98 and second opposing piston 100 are slidably disposed within the second cylinder 58b and are movable along the second longitudinal axis 26b. For example, the pair of second pistons 98, 100 may move toward one another in the first mode of operation and away from one another in the second mode of operation as the pair of second pistons 98, 100 translate between the bottom dead-center position and the top dead-center position. It should be appreciated that the first mode of operation and the second mode of operation occur sequentially during a single engine cycle.

Where the opposed-piston engine 54 is a two-stroke engine, the first mode of operation and the second mode of operation comprise the entirety of the single engine cycle. The intake charge is compressed during the first mode of operation and the intake charge ignites during the second mode of operation where the pistons 64, 66, 98, 100 are driven apart and where a new intake charge enters the cylinder bores 24 and the exhaust gases are expelled. Alternatively, where the opposed-piston engine 54 is a four-stroke engine, the single engine cycle may include two of the first modes of operation and two of the second modes of operation. The single engine cycle may begin with the second mode of operation where the intake charge enters the cylinder bores 24 as the pistons 64, 66, 98, 100 move apart. The intake charge is then compressed in the first mode of operation where the pistons 64, 66, 98, 100 approach one another. The intake charge ignites and the combustion forces the pistons 64, 66, 98, 100 apart in another second mode of operation. Next, the pistons 64, 66, 98, 100 move in another first mode of operation where the pistons 64, 66, 98, 100 again approach one another to expel exhaust gases out of the cylinder bores 24.

Referring to FIGS. 10-12, the pair of crankshafts 74, 76 includes a first crankshaft 74 and a second crankshaft 76. The first crankshaft 74 is coupled to the first piston 64 of the pair of first pistons 64, 66 and to the second piston 98 of the pair of second pistons 98, 100 by a first pair of connecting rods 102. The first crankshaft 74 rotates about a first axis of rotation 104 that is substantially perpendicular to the first longitudinal axis 26a and the second longitudinal axis 26b. Together, the first crankshaft 74 and the first pair of connecting rods 102 link movement of the first piston 64 with movement the second piston 98. Preferably, movement of the first piston 64 opposes movement of the second piston 98 where the first crankshaft 74 is configured such that the second piston 98 moves in accordance with the second mode of operation when the first piston 64 is moving in accordance with the first mode of operation. In other words, the arrangement of the first crankshaft 74 and the first pair of connecting rods 102 is such that the second piston 98 moves towards the second opposing piston 100 when the first piston 64 is moving away from the first opposing piston 66.

The second crankshaft 76 is coupled to the first opposing piston 66 of the pair of first pistons 64, 66 and to the second opposing piston 100 of the pair of second pistons 98, 100 by a second pair of connecting rods 106. The second crankshaft 76 rotates about a second axis of rotation 108 that is substantially perpendicular to the first longitudinal axis 26a and the second longitudinal axis 26b. The second axis of rotation 108 of the second crankshaft 76 is also substantially parallel to and spaced from the first axis of rotation 104 of the first crankshaft 74. Accordingly, the first cylinder 58a and the second cylinder 58b are generally positioned between the first crankshaft 74 and the second crankshaft 76, although the first cylinder 58a and the second cylinder 58b are not necessarily in the same plane as the first and second crankshafts 74, 76. Together, the second crankshaft 76 and the second pair of connecting rods 106 link movement of the first opposing piston 66 with movement the second opposing piston 100. Preferably, movement of the first opposing piston 66 opposes movement of the second opposing piston 100 where the second crankshaft 76 is configured such that the second opposing piston 100 moves in accordance with the second mode of operation when the first opposing piston 66 is moving in accordance with the first mode of operation. In other words, the arrangement of the second crankshaft 76 and the second pair of connecting rods 106 is such that the second opposing piston 100 moves towards the second piston 98 when the first opposing piston 66 is moving away from the first piston 64. The opposed-piston engine 54 may include a gear train 78 that synchronizes rotation of the first and second crankshafts 74, 76 such that the first piston 64 and the first opposing piston 66 begin the first and second modes of operation at the same time and such that the second piston 98 and the second opposing piston 100 begin the first and second modes of operation at the same time.

Referring to FIG. 11, a first combustion chamber 110 is disposed within the first cylinder 58a between the first piston 64 and the first opposing piston 66. A first fuel injector 112 may optionally be provided where the first fuel injector 112 extends through the cylinder wall 22 of the first cylinder liner 90 such that the first fuel injector 112 is disposed in fluid communication with the first combustion chamber 110. Thus, the first fuel injector 112 may be operated to inject fuel into the first combustion chamber 110 during the first mode of operation. Where the opposed-piston engine 54 is a compression ignition engine, the fuel injected into the first combustion chamber 110 is compressed and ignites as the first piston 64 and the first opposing piston 66 approach one another. Alternatively, where the opposed-piston engine 54 is a spark ignition engine, a first spark plug 114 may be provided. The first spark plug 114 may generally extend through the cylinder wall 22 of the first cylinder liner 90 such that the first spark plug 114 is disposed in fluid communication with the first combustion chamber 110. The first spark plug 114 may be operated to supply a spark to the first combustion chamber 110 to initiate combustion therein.

With reference to FIG. 12, a second combustion chamber 116 is disposed within the second cylinder 58b between the second piston 98 and the second opposing piston 100. A second fuel injector 118 may optionally be provided where the second fuel injector 118 extends through the cylinder wall 22 of the second cylinder liner 92 such that the second fuel injector 118 is disposed in fluid communication with the second combustion chamber 116. Thus, the second fuel injector 118 may be operated to inject fuel into the second combustion chamber 116 during the first mode of operation. Where the opposed-piston engine 54 is a compression ignition engine, the fuel injected into the second combustion chamber 116 is compressed and ignites as the second piston 98 and the second opposing piston 100 approach one another. Alternatively, where the opposed-piston engine 54 is a spark ignition engine, a second spark plug 120 may be provided. The second spark plug 120 may generally extend through the cylinder wall 22 of the second cylinder liner 92 such that the second spark plug 120 is disposed in fluid communication with the second combustion chamber 116. The second spark plug 120 may be operated to supply a spark to the second combustion chamber 116 to initiate combustion therein. As shown in FIGS. 10, 11, and 12, the fuel injectors 112, 118 and the spark plugs 114, 120 may be diametrically arranged relative to the cylinder bores 24. Additionally, the first fuel injector 112 and the second spark plug 120 may be arranged on one side of the engine block 56 while the first spark plug 114 and the second fuel injector 118 are arranged on an opposite side of the engine block 56. Of course other arrangements are possible and each cylinder may be equipped with multiple fuel injectors and/or spark plugs.

The first and second inlet ports 60, 94 may be positioned longitudinally on one side of the first and second fuel injectors 112, 118 and the first and second exhaust ports 62, 96 may be positioned longitudinally on an opposite side of the first and second fuel injectors 112, 118. In FIGS. 10-12 for example, the first and second inlet ports 60, 94 are to the right of the first and second fuel injectors 112, 118 while the first and second exhaust ports 62, 96 are to the left of the first and second fuel injectors 112, 118. An inlet manifold 122 may thus be arranged in fluid communication with the first inlet port 60 and the second inlet port 94. The inlet manifold 122 shown in FIG. 10 is at least partially disposed within the engine block 56 and transports air to the first inlet port 60 and the second inlet port 94 and thus the first and second combustion chambers 110, 116 respectively. Similarly, an exhaust manifold 124 may be arranged in fluid communication with the first exhaust port 62 and the second exhaust port 96. The exhaust manifold 124 shown in FIG. 10 is at least partially disposed within the engine block 56 and transports exhaust expelled from the first and second combustion chambers 110, 116 away from the first and second exhaust ports 62, 96.

The cylinder bore 24 of the first cylinder 58a and the cylinder bore 24 of the second cylinder 58b each has a bore cross-section 28 that is perpendicular to the first and second longitudinal axes 26a, 26b. The cylinder wall 22 of the first cylinder liner 90 and the cylinder wall 22 of the second cylinder liner 92 each includes an inner surface 32 facing the pair of first pistons 64, 66 and the pair of second pistons 98, 100 respectively. Each piston 64, 66, 98, 100 of the pair of first pistons 64, 66 and the pair of second pistons 98, 100 has a piston crown 34 spanning the bore cross-section 28 and at least one ring groove 36 that extends annularly about each of the pistons 64, 66, 98, 100 in a ring plane 38 that is perpendicular to the first and second longitudinal axes 26a, 26b. Thus, it should be appreciated that the bore cross-section 28 and the ring plane 38 are parallel to one another for each cylinder 58a, 58b, 58c, 58d, 58e, 58f and piston 30a, 30b, 30c, 30d, 30e, 30f in the opposed-piston engine 54. A piston ring 40 is received in each ring groove 36 of each piston 30a, 30b, 30c, 30d, 30e, 30f. The piston rings 40 have an annular shape and extend radially from each of the pistons 30a, 30b, 30c, 30d, 30e, 30f within the ring plane 38 to seal against the inner surface 32 of the cylinder wall 22.

Each of the first and second inlet ports 60, 94 and each of the first and second exhaust ports 62, 96 include a plurality of windows 44 that are circumferentially spaced from one another about the cylinder wall 22. Each window 44 of the plurality of windows 44 has a window perimeter 46 that extends about each window 44 of the plurality of windows 44 adjacent the inner surface 32 of the cylinder wall 22. Accordingly, the window perimeters 46 of the plurality of windows 44 cooperatively form the first and second inlet ports 60, 94 and the first and second exhaust ports 62, 96. Each of the first and second inlet ports 60, 94 and each of the first and second exhaust ports 62, 96 have an oblique geometry 48. That is, each of the first and second inlet ports 60, 94 and each of the first and second exhaust ports 62, 96 extends circumferentially about the cylinder bore 24 in a path 50 that forms an oblique angle with the ring plane 38 to stagger entry and exit times of the piston rings 40 relative to the plurality of windows 44 the first and second inlet ports 60, 94 and the first and second exhaust ports 62, 96 as the pair of first pistons 64, 66 and the pair of second pistons 98, 100 reciprocate within the first cylinder 58a and the second cylinder 58b respectively. Therefore, the piston rings 40 cross the only some of the windows 44 of the first and second inlet ports 60, 94 and only some of the windows 44 of the first and second exhaust ports 62, 96 at any given moment in time so that ring clipping does not occur.

As shown in FIGS. 11 and 12, the piston crown 34 of each of the pistons 64, 66, 98, 100 has a periphery 52 adjacent the cylinder wall 22 that forms and oblique angle with the ring plane 38 and that has a shape corresponding to the oblique geometry 48 of the first and second inlet ports 60, 94 and the first and second exhaust ports 62, 96. Due to this shape, the periphery 52 of the piston crown 34 of the first and second pistons 64, 98 opens and closes the first and second inlet ports 60, 94 at substantially the same time (i.e. evenly) along their oblique geometry 48. Likewise, this shape allows the periphery 52 of the piston crown 34 of the first and second opposing pistons 64, 100 to open and close the first and second exhaust ports 62, 96 at substantially the same time (i.e. evenly) along their oblique geometry 48. The periphery 52 of the piston crown 34 of each of the pistons 64, 66, 98, 100 may have high areas 68 and low areas 70. Accordingly, the pair of first pistons 64, 66 and the pair of second pistons 98, 100 may be arranged to nest in the top dead-center position. For example, the first piston 64 and the first opposing piston 66 may be phased such that the high areas 68 of the first piston 64 interface with the low areas 70 of the first opposing piston 66 and the low areas 70 of the first piston 64 interface with the high areas 68 of the first opposing piston 66 when the pair of first pistons 64, 66 are at the top dead-center position. The second piston 98 and the second opposing piston 100 may be similarly phased such that the high areas 68 of the second piston 98 interface with the low areas 70 of the second opposing piston 100 and the low areas 70 of the second piston 98 interface with the high areas 68 of the second opposing piston 100 when the pair of second pistons 98, 100 are at the top dead-center position. Such an arrangement provides closer approach of the pistons 64, 66, 98, 100 at the top dead-center position and thus provides increased compression and packaging benefits. Notwithstanding, the oblique port geometry and the corresponding piston crown shape disclosed herein may be utilized without phasing the piston 64, 66, 98, 100 to nest with one another.

Many modifications and variations of the disclosed engine assembly 20 and opposed-piston engine 54 are possible in light of the above teachings and may be practiced otherwise than as specifically described while within the scope of the appended claims. These antecedent recitations should be interpreted to cover any combination in which the inventive novelty exercises its utility. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described.

What is claimed is:

1. An engine assembly comprising:
a cylinder wall extending about a cylinder bore, said cylinder bore defining a longitudinal axis;
a piston slidingly received within said cylinder bore that is movable along said longitudinal axis, said piston including at least one ring groove that extends about said piston in a ring plane that is transverse to said longitudinal axis;
at least one piston ring received in said at least one ring groove;
at least one port including a plurality of windows that extend through said cylinder wall, each window of said plurality of windows being open to said cylinder bore; and
said at least one port having an oblique geometry relative to said ring plane wherein said plurality of windows extend at least partially about said cylinder bore in a path that is oblique to said ring plane to stagger entry and exit times of said at least one piston ring relative to said plurality of windows as said piston reciprocates within said cylinder bore.

2. An engine assembly as set forth in claim 1 wherein said piston includes a piston crown having a periphery adjacent said cylinder wall that has a shape corresponding to said oblique geometry of said at least one port such that said periphery of said piston crown opens and closes said plurality of windows at substantially the same time along said oblique geometry of said at least one port as said piston reciprocates within said cylinder bore.

3. An engine assembly as set forth in claim 2 wherein said oblique geometry of said at least one port and said shape of said periphery of said piston crown follows a sinusoidal path adjacent said cylinder wall.

4. An engine assembly as set forth in claim 2 wherein at least portions of said periphery of said piston crown are oblique to said ring plane.

5. An engine assembly as set forth in claim 2 wherein said cylinder bore has a bore cross-section that is perpendicular to said longitudinal axis and said piston crown spans said bore cross-section.

6. An engine assembly as set forth in claim 5 wherein said ring plane is parallel with said bore cross-section.

7. An engine assembly as set forth in claim 1 wherein said plurality of windows circumscribe said cylinder bore.

8. An engine assembly as set forth in claim 1 wherein said plurality of windows are circumferentially spaced from one another about said cylinder wall.

9. An engine assembly as set forth in claim 8 wherein each window of said plurality of windows has a window perimeter adjacent said cylinder wall where said window perimeter of each window in said plurality of windows defines said oblique geometry of said at least one port.

10. An engine assembly as set forth in claim 1 wherein said at least one port is an inlet port.

11. An engine assembly as set forth in claim 1 wherein said at least one port is an exhaust port.

12. An engine assembly comprising:
a cylinder wall extending annularly about and defining a cylinder bore;
said cylinder bore defining a longitudinal axis that extends co-axially through said cylinder bore;
said cylinder bore having a bore cross-section that is perpendicular to said longitudinal axis, said bore cross-section having a circular perimeter;
a piston slidingly received within said cylinder bore for reciprocal movement therein along said longitudinal axis between a bottom dead-center position and a top dead-center position;
said cylinder wall including an inner surface facing said piston;
said piston including a piston crown spanning said bore cross-section and at least one ring groove that extends annularly about said piston in a ring plane that is perpendicular to said longitudinal axis and parallel to said bore cross-section;
at least one piston ring received in said at least one ring groove, said piston ring having an annular shape and said at least one piston ring extending radially from said piston within said ring plane to seal against said inner surface of said cylinder wall;
said cylinder wall having at least one port that includes a plurality of windows extending through said cylinder wall;
each window of said plurality of windows being open to said cylinder bore and having a window perimeter extending about each window of said plurality of windows adjacent said inner surface of said cylinder wall;
said at least one port having an oblique geometry relative to said ring plane where said plurality of windows are circumferentially spaced from one another about said cylinder bore in a path that is oblique to said ring plane to stagger entry and exit times of said at least one piston ring relative to said plurality of windows as said piston reciprocates within said cylinder bore between said bottom dead-center position and said top dead-center position; and
said piston crown having a periphery adjacent said cylinder wall that is oblique to said ring plane and that has a shape corresponding to said oblique geometry of said at least one port such that said periphery of said piston crown opens and closes said plurality of windows at substantially the same time along said oblique geometry of said at least one port as said piston reciprocates within said cylinder bore between said bottom dead-center position and said top dead-center position.

13. An opposed-piston engine comprising:
an engine block including a cylinder wall that extends about and defines a first cylinder, said first cylinder having a first longitudinal axis and a first inlet port and a first exhaust port that is longitudinally spaced from said first inlet port;
a pair of first pistons including a first piston and a first opposing piston that are slidably disposed within said first cylinder and that are movable along said first longitudinal axis toward one another in a first mode of operation and away from one another in a second mode of operation;
each piston of said pair of first pistons including a piston crown and at least one ring groove that extends about each piston of said pair of first pistons in a ring plane that is perpendicular to said first longitudinal axis;
at least one piston ring received in said at least one ring groove of each piston of said pair of first pistons; and
at least one of said first inlet port and said first exhaust port having an oblique geometry thereby defining at least one oblique port where said at least one oblique port includes a plurality of windows extending at least partially about said first cylinder in a path that is oblique to said ring plane to stagger entry and exit times of said at least one piston ring relative to said plurality of windows of said at least one oblique port as said pair of first pistons translate within said first cylinder.

14. An opposed-piston engine as set forth in claim 13 wherein said piston crown of at least one piston of said pair of first pistons has a periphery that corresponds to said oblique geometry of said at least one oblique port thereby defining at least one oblique piston crown where said periphery of said at least one oblique piston crown opens and closes said plurality of windows of said at least one oblique port at substantially the same time as said pair of first pistons translate within said first cylinder.

15. An opposed-piston engine as set forth in claim 14 wherein said oblique geometry of said at least one oblique port and said periphery of said at least one oblique piston crown follow a sinusoidal path adjacent said cylinder wall.

16. An opposed-piston engine as set forth in claim 13 wherein both of said first inlet and exhaust ports have said oblique geometry where each of said first inlet and exhaust ports have a plurality of windows that extend at least partially about said first cylinder in a path that is oblique to said ring plane to stagger entry and exit times of said at least one piston ring relative to said plurality of windows of each of said first inlet and exhaust ports as said pair of first pistons translate within said first cylinder.

17. An opposed-piston engine as set forth in claim 16 wherein said periphery of said piston crown of said first piston and said periphery of said piston crown of said first opposing piston have shapes that corresponds to said oblique geometry of said first inlet and exhaust ports such that said periphery of said piston crown of said first piston opens and closes said plurality of windows of said first inlet port at substantially the same time and such that said periphery of said piston crown of said first opposing piston opens and closes said plurality of windows of said first exhaust port at substantially the same time as said pair of first pistons translate within said first cylinder.

18. An opposed-piston engine as set forth in claim 17 wherein said periphery of said piston crown of said first piston has high areas and low areas and said periphery of said piston crown of said first opposing piston has high areas and low areas.

19. An opposed-piston engine as set forth in claim 18 wherein said first piston and said first opposing piston are phased such that said high areas of said first piston interface with said low areas of said first opposing piston and said low areas of said first piston interface with said high areas of said first opposing piston so that said first piston and said first opposing piston nest with one another as said first piston and said first opposing piston approach one another during said first mode of operation.

20. An opposed-piston engine as set forth in claim 13 wherein said first inlet and exhaust ports each have a plurality of windows that circumscribe said first cylinder.
